(19) United States
(12) Patent Application Publication
(10) Pub. No.: US 2010/0080399 A1
(43) Pub. Date: Apr. 1, 2010

(54) Method For Reducing Vehicle Noise

(75) Inventors: Douglas Allen Pfau, Canton, MI (US); David Michael Whitton, Saline, MI (US)

Correspondence Address: DICKINSON WRIGHT PLLC, 1875 Eye Street, NW, Suite 1200, WASHINGTON, DC, 20006, US

(73) Assignee: VISTEON GLOBAL TECHNOLOGIES, INC., Van Buren Township, MI (US)

(21) Appl. No.: 12/241,529

(22) Filed: Sep. 30, 2008

(51) Int. Cl. G10K 11/16

(52) U.S. Cl. 381/71.4

(57) ABSTRACT

A method for reducing noise in a vehicle by reducing under certain conditions the rotational speed of certain rotational components.

### BACKGROUND OF THE INVENTION

1. Field of the invention

The present invention relates to a method for reducing noise in a vehicle and more specifically, to a method for reducing the audible noise in the interior of a vehicle from rotating components such as fans.

2. Discussion

Consumers, and in particular, automobile consumers, have long associated quiet vehicle interiors with luxury and quality. In response, vehicle manufacturers have continually strived to reduce noise levels in the interior of vehicles. The primary causes of noise in vehicle interiors are road, air and engine noise. Over the past years, most gains in noise reduction are from quieter tires, increasing amounts of insulation, and improved vehicle shapes that improve fuel economy and reduce wind noise. One problem with reducing road noise using only additional insulation is that the insulation adds weight to the vehicle which in turn is in opposition to the desire to improve fuel economy through removing weight from vehicles.

One component that traditionally produces audible noise within a vehicle interior is the heating and cooling fan or blower. As the noise levels in the interior of vehicles is increasingly diminished, occupants of the vehicle are increasingly noticing noise from such fans or blowers. Traditionally, consumers manually set the fan speed to provide a balance between the amount of desired heating or cooling and, the associated noise level for that particular fan speed. If the particular speed of a fan was too noisy, the speed would be manually adjusted. As more systems automatically maintain a desired temperature and that is set by a vehicle occupant, and the system then automatically adjusts the fan speed as well as other vehicle components to provide the necessary hot or cold air to the vehicle interior, vehicle occupants have increasingly noticed the noise level of the fan or blower. One such reason is that it is difficult to adjust the tan speed on many automatic systems and as the fan cycles between speeds to maintain the desired temperature, the noise levels, especially as the fan cycles to a faster setting are particularly noticed by the occupants of a vehicle.

In an attempt to address complaints related to the noise level of the fan or blower, manufacturers have redesigned the shape of the fan blades, vents and other components to reduce audible noise. To maintain efficient movement of air by the vehicle fan, many of these redesigns to the fan shapes are limited. Therefore, it is difficult to obtain any further noise reductions from redesigning the shape of the fan blades or vents and it is desirable to find other ways to reduce the audible noise produced by a rotating components in vehicles, in particular for automatic controlled climate systems where a fan maintains the vehicle temperature without consideration to the noise caused by the fan.

As the noise levels in the vehicle interiors have been reduced, consumers have also increasingly noticed noises from rotating components other than the heating and cooling fan in the vehicles. These rotating components are typically cooling fans for various electronic items in the vehicle such as vehicle radios, navigation systems, CD players and changers, instrument panels, and cooling fans for seats. Traditionally all of these fans were not audible to the occupant of a vehicle's interior as they were overwhelmed by the ambient wind and road noises experienced by the vehicle's occupant. As vehicle interior noise levels have been reduced, some of these items are now noticeable to vehicle occupants and in particular at slower speeds where the ambient road noise and wind noise is minimal. Some consumers have been frustrated by their inability to control such components to reduce noise.

### SUMMARY OF THE INVENTION AND ADVANTAGES

The present invention is directed to a method for reducing audible noise in a vehicle and more particularly to a method for reducing the audible noise in the interior of the vehicle from rotating components such as fans, including heating and cooling fans for the temperature control in the vehicle as well as fans for cooling seats, CD changers and other electronic devices.

The method includes the steps of providing a rotational speed signal indicating the rotational speed of the rotating components such as a fan. Then providing a vehicle status signal indicating at least one of a vehicle speed and engine RPM. The system then, in response to the rotational speed signal and the at least one vehicle status signal, adjusts the rotational speed of the rotating component in response to changes in the vehicle status signal or in response to the vehicle status signal meeting certain threshold requirements.

More particularly, the method reduces the audible noise from the rotating components such as a fan in response to low or reduced ambient vehicle noise. Above certain vehicle speeds or engine RPM, any change in fan speed may not be audible to the occupant of the vehicle. When the vehicle speed or engine RPM falls below a certain threshold, the fan speed may be adjusted to reduce noise. Below the desired speed or engine RPM threshold, as the vehicle speed or engine RPM is reduced, the rotational speed of the fan is also reduced. Of course, in certain instances where the desired interior vehicle temperature is significantly different from the actual vehicle interior, the system may override any reduction in fan speed to ensure maximum cooling or heating to the vehicle interior until the actual temperature is at or within a specified range of the desired temperature. For other components such as cooling fans on electronic components, the system may override any reduction in fan speed if it is determined that an overheat situation exists and maximum cooling of the electronic component is needed.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

Other advantages of the present invention will be readily appreciated and more fully understood by reference to the following detailed description when considered in connection with the accompanying drawing wherein:

FIG. 1 is a schematic diagram of an exemplary system.

### DETAILED DESCRIPTION OF THE INVENTION

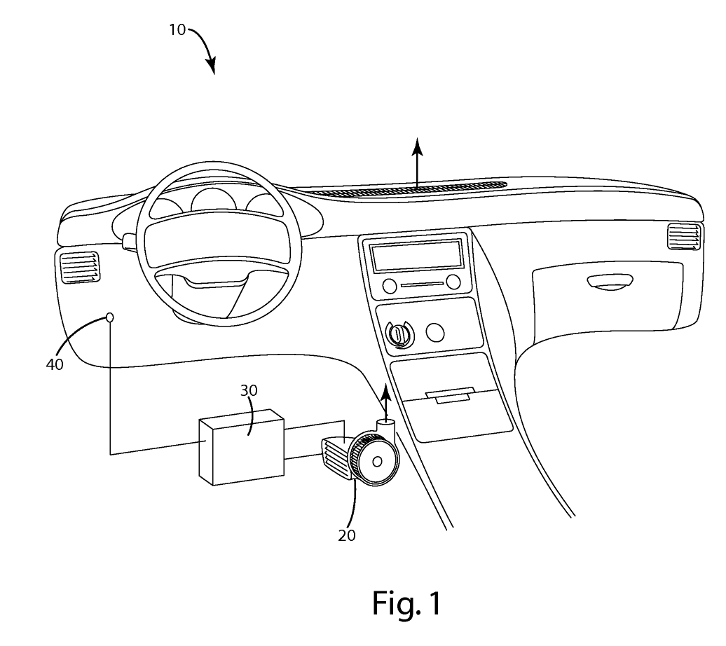

The present invention is directed to a method for controlling noise audible to the occupant of a vehicle. An exemplary system 10 configured to fit within the vehicle (not shown) and capable of performing the method of the present invention is generally illustrated in FIG. 1. As illustrated in FIG. 1, the system 10 generally includes a rotational component 20 such as a fan that is controlled at least in part by a controller 30. The controller 30 is generally responsible for adjusting the speed of the rotational component 20 in response to various vehicle status inputs.

The system 10 and method may be used in any type of vehicle, but is particularly applicable to automobiles, such as trucks, cars, crossovers, and vans. As described in greater detail above, manufacturers have continually strived to reduce sound or noise levels in a vehicle's interior. As road noise, audible within the interior of a vehicle, has been reduced over time, other components have become audible to the occupants of a vehicle. In particular, fans for moving air, such as to provide heating or cooling to the interior of a vehicle or cooling of various components, have become more audible to the occupants of the vehicle. In particular, at slower speeds as manufacturers have successfully reduced other sources of noise in the vehicle, which now causes fans to be one of the more audible noises to the occupants of a vehicle. As fans are tasked with moving air, they typically produce both motor noise as well as a blade noise from the blades creating turbulence in the air.

The most common rotational component or blower that causes noise audible to the vehicle occupants is the fan or blower used for the heating and cooling system that provides temperature control for the interior of the vehicle. The most common fan or blower used for heating or cooling vehicle interiors is typically a squirrel-cage blower, capable of delivering large volumes of air for its size. By design, squirrel-cage blowers are typically noisy, even though manufacturers have strived to reduce the noise these blowers create by reducing the motor noise as well as redesigning the blades or vanes on the blowers to reduce air turbulence. The problem is that designs that efficiently move air are typically not the quietest designs. As road noise and other noises audible within the interior of the vehicle is reduced, occupants of the vehicle's interior have increasingly noticed sound produced by the heating and cooling blower.

The heating and cooling fan or blower is commonly driven by a blower motor. In a vehicle having manual selected heating controls, occupants typically use the switch to manually select the various blower resistors that have varying resistance to change the speed of the blower motor. More specifically, typically the highest speed has minimal resistance while each subsequently slower speed has increasing resistance selected by the switch. A blower relay may be used in some embodiments in combination with the blower resistors to select the blower speed. In comparison, most automatic climate control systems directly control the blower motor, and thereby the speed of the blower through varying the current to the motor without using traditional blower resistors and without any change from the operator of the vehicle.

The present invention uses a controller 30 that controls the speed of the rotational component to reduce the amount of noise from rotating components, such as fans, and in particular heating and cooling blowers for vehicle interiors. The noise of these rotating components is specifically reduced when the controller 30 senses that the noise in the interior of vehicle is being reduced or below a certain threshold. The controller 30 passively senses that the noise in the vehicle is being reduced through various inputs and does not actively or directly measure the noise level in the vehicle interior. Therefore, the controller 30 uses various vehicle status signals, such as vehicle speed and/or engine RPM to determine when the noise is being reduced below a level where it is desirable to reduce noise from various rotating components. By using only existing vehicle status signals, the present invention can be added to vehicles with minimal cost as status signals such as vehicle speed and engine RPM are readily available. Therefore, the system 10 is able to efficiently and cost-effectively reduce noise in the vehicle interior without the addition of expensive feedback components such as microphones for measuring noise levels. The controller 30 may be any controller capable of performing the methods and functions described and claimed in this application. Of course, the controller 30 may be any existing vehicle controller and in particular, any current controller on a vehicle that controls the heating and cooling within a vehicle interior. The controller 30 may be located within a vehicle computer, a controller for the heating and cooling system, or any other controller that is capable of receiving the vehicle status signals such as engine RPM and vehicle speed and then providing either directly or indirectly an output to reduce the speed of the blower motor.

As the number of electronic components in a vehicle increases, the number of cooling fans in the vehicle has also increased. For example, many radios, CD players and CD changers, GPS navigation systems, and other electronic devices use cooling fans. As vehicles have become more compact, some instrument panels also now require cooling fans to ensure reliable, long-term operation of the components. Other luxury vehicles have even added cooling fans to the vehicle seats to pull air through the seat and thereby cool the surface of the seat to provide a comfortable ride. Each one of these additional cooling fans is also capable of being controlled as part of the present invention in addition to or exclusive to the blower for the heating and cooling system.

The method of the present invention generally includes various steps that during certain operating conditions of the vehicle slow the speed of certain rotating components to reduce noise in the interior of the vehicle. More specifically, due to the reduction in vehicle noise or noise in the interior of the vehicle being below a specified level, the system 10 reduces the rotational speed of the rotating components 20 to minimize or prevent any noise from the rotational component 20 being audible to the occupants in the vehicle. Changes in the vehicle status or reductions in vehicle noise commonly occur due to reductions in vehicle speed or reductions in engine RPM and more specifically, reductions in vehicle speed as well as engine RPM

Although not required, it may be helpful to create a noise map or noise profile for each vehicle. A noise profile allows the system to efficiently and accurately identify when the rotating component 20 should have reduced rotational speed and when it is unnecessary to reduce the rotational speed to reduce noise within the interior of the vehicle. Not reducing the rotational speed when any reduction is not necessary ensures that the component or system containing the rotational component operates at maximum efficiency and without interference when the system determines that no noise reduction is necessary. As any reduction in rotational speed of the rotating component may reduce the efficiency of the system or of the component containing the rotational component, it is desirable to minimize reductions in speed in the rotational component to where an audible reduction occurs.

The noise profile of a vehicle is generally created by mapping the noise of the vehicle at various speeds and at various engine RPM's. The primary factor in creating a noise profile is typically the speed of the vehicle. It is expected that above certain speeds, the noise in the vehicle will make changes to the rotational speed of the rotational component unnecessary as any such changes from at least all but the maximum speed of the heating and cooling blower will not cause significant noise reductions. Furthermore, for other components such as cooling fans that typically do not have as high of a velocity air movement as the heating and cooling blower, reductions in these fans or rotating components typically are not necessary at all but at the slowest of the speeds and minimal engine RPM's. Therefore, the noise profile or noise map allows manufacturers to tailor each individual vehicle to maximize efficiency and noise reductions by only reducing speed when any reduction in speed of a particular rotational component being controlled is noticeably audible to the occupant of the vehicle and not doing such reductions where point reductions in rotational speed are not necessary.

Once the noise profile of a particular vehicle is determined, it may be desirable to create a noise profile of the rotational component that is being controlled. Of course, this step may be accomplished as part of the creation of a noise profile of the overall vehicle. In such a noise profile the vehicle is noise mapped or profiled repeatedly at various speeds with the rotational components set to different levels. The noise profile may be then analyzed to determine the specific vehicle states or specific ranges or levels on a vehicle status signal where the rotational component should be slowed to reduce noise. Determination may also be made of the levels or signals where the rotational component does not need to be slowed as any reduction in noise from the rotational component will not significantly affect the noise within the vehicle cabin or be typically noticed by the occupants of the vehicle's interior.

After the noise profile map is created for the vehicle and the points determined for each rotational component where slowing of the rotational component causes a noticeable reduction in sound, or where changes in certain vehicle status signals should cause changes in the rotational speed of the component, these points or ranges are then uploaded into the controller 30. The controller 30 is also programmed to not control the rotational component during certain states and initiate control during other states. For example, a vehicle traveling at a speed greater than 40 mph may not require any control of the rotational component as any reduction in speed of the rotational component would be unnecessary as the noise from the rotational component is not noticeable to the occupants and more specifically the reduced noise from the rotational component due to the slowing of the rotational component would not be noticed by the occupants of the vehicle. Therefore, at speeds above 40 mph, the controller would not reduce rotational speed of the rotational component. Once the vehicle is traveling under 40 mph, the system may initiate control. In addition, the controller may also not activate control over the rotational component when the engine RPM is above a certain level such as when the vehicle is accelerating toward 40 mph as the noise from the engine in addition to the noise from the particular vehicle's speed would minimize the effect of any reduction in noise from the rotational component. The particular speed or rpm levels where the rotational component may or may not be controlled are vehicle speeds.

Other factors that a controller may look for are decreases in the vehicle speed. By continually checking for changes in vehicle speed, the controller may decrease or increase the rotational component as needed to adjust for such changes. It is expected that to prevent oscillation of the rotational component that any changes experienced such as in vehicle speed need to be above a specified amount before control over the rotational component is initiated or after a time delay. For example, the change in speed over a particular time period may need to be greater than a certain number of miles per hour as anything less may cause the component to oscillate. In one particular example, a cruise control is allowed flexibility to vary above and below the set desired speed to increase fuel economy. Over a varied terrain, such as hilly terrain, the cruise control may allow the vehicle speed to change before it initiates control and brings back the vehicle speed to the desired speed. If the controller 20 controlled the rotational component exactly in coordination with the variance in speed, the occupant of the vehicle may notice oscillation of the fan in combination with changes in vehicle speed. Therefore, the controller 30 would be set to ignore the changes in vehicle speed within certain parameters. The particular rotational component 20 being controlled may also require variance in desired vehicle operating conditions or vehicle status signals before control is initiated. For example, control over the heating and cooling blower may be initiated at a much higher vehicle speed than control over a cooling fan such as a CD changer or radio cooling fan.

During operation of the vehicle, the controller 30 typically monitors certain vehicle status signals. A primary vehicle status signal is the speed of the vehicle. Other optional or searching vehicle status signals that are monitored may include engine RPM, status of the vehicle windows such as are they open or closed, status of the sunroof, status of the vehicle radio or entertainment system, and transmission gear. Therefore, in some instances, control may not be necessary to be initiated below certain vehicle speeds where it normally would be initiated as the noise level in the vehicle would be high enough to not initiate control, such as, the windows being open or the vehicle radio being set to a volume level that any change in rotational speed of the rotational component will not be audibly noticed by the occupant of the vehicle. Therefore, the controller looks for vehicle status signals within a desired range, optionally looks for changes in the vehicle status signal, and optionally looks at additional status signals to modify control parameters

Noise maps may be more finely tuned to an individual's current use of the vehicle to provide reduced audible noise, while also maximizing the cooling efficiency of the HVAC fan, or operational efficiency of the rotational component being controlled. More specifically, using additional vehicle status signals in addition to vehicle speed and engine rpm provides a balance between operational efficiency and a reduction in audible noise. Exemplary status signals include a window position status signal, an audio level status signal for the vehicle entertainment system, a mobile phone in use status signal and any other desired vehicle status signal that may affect the operator's ability to hear noise from the rotational component, or at a minimum, the operator's perception of noise produced by the rotational component. The above listed vehicle status signals are secondary vehicle status signals, while the vehicle speed and engine rpm vehicle status signals are primary vehicle status signals. A noise profile may use one or more secondary vehicle status signals in addition to at least one primary vehicle status signal.

The standard noise profile for a primary vehicle status signal may be modified depending on the received secondary vehicle status signal. For example, if the secondary vehicle status signal is a window status signal, upon receiving a signal that a window status is open, the system may prevent implementation of control, delay of control or implement modification of control of the rotational component. More specifically, the standard noise profile and adjustments to the rotational speed of the rotational component may be modified when the windows of the vehicle are open, and a window status signal signifying such open condition is received. When vehicle windows are open, the noise level in the vehicle is typically increased. Such an increase in noise level would change the vehicle speed or engine rpm where it is desirable to initiate control to minimize audible noise form the rotational component. Therefore, in response to an open window status signal and without the need for active feedback input, the system would change the vehicle speed at which control of the rotational component is initiated. In most instances, the speed at which control would be initialized would be lowered. This in turn maximizes the available efficiency of the rotational component. For example, on a chilly day with a convertible top down or windows open on a vehicle, the operate may desire to receive heat and the changing noise profile maximizes the provisions of heat and reduces rotational speed only when such control is needed to reduce audible noise when the top is down or the windows are down.

As stated above, other second vehicle status signals include audio level, mobile phone use and may even include a rain sensor. Rain or water on the roads typically increases the amount of noise in a vehicle cabin and therefore, the vehicle speed at which control is initiated may be higher. This maximizes the use of the condenser on the HVAC system to remove moisture from the interior while only reducing rotational speed of the component when noise may be audible in view of water on road or rain. When using an audible level or status as a secondary vehicle status, initiation of control of the rotational component may vary depending on for example, the volume status. The higher the audio volume, the lower the vehicle speed at which control is initiated. For some audio levels, control may never be initiated and override control of the rotational components. Most entertainment systems are able to provide an audio level signal and initiation of control may vary depending upon the current audio level. Some vehicles directly or via Bluetooth integrate cell phones. It is common for the vehicle entertainment system to be muted in response to use of a connected mobile phone in the vehicle. As it is desirable to minimize audible noise in the vehicle cabin during a mobile phone telephone call, upon receiving a secondary vehicle status signal that the mobile phone is in use, a much stricter control parameter may be initiated, such as control of the rotational component occurring at higher vehicle speeds to maximize reductions in audible noise, as compared to when the secondary status signal indicates that a mobile phone is not in use.

In response to the vehicle status signals being within the desired range, the controller may control current to the motor driving the rotational component or to a relay to initiate the desired control of the rotational component. When control is initiated, typically the current supplied to the motor controlling the rotational component is reduced such that the rotational speed of the rotational component is also reduced.

In certain operating conditions, the vehicle controller may receive other status inputs that cause an override in the control system. More specifically, if the rotational component being controlled is the cooling fan for a CD changer, if the CD changer is within an operating temperature that is close to the desired limit, the controller may cease its reduction or not initiate a reduction in the rotational speed of the rotating component, even though all other criteria for such reduction and speed are met. This allows an increase in or maintenance of the rotational speed to ensure that the CD changer is sufficiently cooled to prevent damage to the components of the CD changer. Likewise, if the interior temperature of the vehicle is significantly different than the desired interior temperature set by the operator of the vehicle, the controller may cease its reduction in rotational speed of the rotational component to allow for more efficient heating or cooling of the vehicle interior. For example, if the occupants of the vehicle desire the interior temperature to be 72° and the actual interior temperature is 78°, the controller may cease its control over the cooling fan and allow the fan to increase in rotational speed to allow a more efficient cooling to the interior of the vehicle. The desired deviations from the desired temperature before control over the rotational component is ceased may be set by the manufacturer of the vehicle.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A method for controlling the noise output of a rotating component in a vehicle, said method comprising:
providing a rotational speed signal indicating the rotational speed of the rotating component;
providing a vehicle status signal indicating at least one of the vehicle speed and engine rpm:
adjusting the rotational speed of the rotating component in response to changes in said vehicle status signal.

2. The method of claim 1 wherein said step of adjusting the rotational speed further includes the steps of:
determining at least one of the current engine rpm or the current vehicle speed and
determining the amount of change in the vehicle status signal over a predetermined time period.

3. The method of claim 2 wherein the amount of adjustment during said step of adjusting the rotational speed of the rotating component varies in response to at least one of said determined engine rpm and current vehicle speed, and said determined amount of change in the vehicle status signal over a predetermined time period.

4. The method of claim 1 wherein said rotating component is a fan.

5. The method of claim 4 wherein the rotational speed of said fan is decreased in response to a decrease in vehicle speed.

6. The method of claim 1 wherein the amount of adjustment in said step of adjusting the rotational speed of the rotating component varies based upon the current vehicle speed in addition to the change in vehicle speed.

7. The method of claim 1 further including the steps of:
providing a temperature status signal; and
adjusting the rotational speed of the rotating component in response to said temperature status signal.

8. The method of claim 7 wherein said step of adjusting the rotational speed in response to said temperature status signal is prioritized over said step of adjusting the rotational speed in response to said vehicle status signal.

9. The method of claim 7 further including the step of monitoring said temperature status signal and said step of adjusting the rotational speed in response to said temperature status signal is only performed when said temperature status is within a predetermined range.

10. The method of claim 9 wherein said predetermined range may change due to input from the occupants of the vehicle.

11. The method of claim 7 further including the steps of monitoring the temperature status signal and preventing any adjustments in response to said vehicle status signal when said temperature status signal in a predetermined range.

12. The method of claim 1 further including the steps of:
monitoring a temperature status signal;
overriding said step of adjusting said rotational component in response to changes in the vehicle status signal, in further response to said temperature status signal.

13. The method of claim 1 further including the steps of:
monitoring a window open status signal;
overriding said step of adjusting said rotational component in response to changes in the vehicle status signal, in further response to said window open status signal.

14. The method of claim 1 further including the steps of:
monitoring said vehicle speed status signal;
overriding said step of adjusting said rotational component in response to changes in the vehicle status signal when said vehicle speed status signal is above a specified amount.

15. A method for controlling the audible noise output of a fan in a vehicle, said method comprising:
providing a fan speed signal;
providing a vehicle speed signal; and
adjusting the fan speed in response to changes in said vehicle speed signal.

16. The method of claim 15 wherein the fan speed is reduced as the vehicle speed is reduced.

17. The method of claim 16 wherein said reduction in fan speed is not proportional to said reduction in vehicle speed within specified vehicle speed ranges.

18. The method of claim 16 wherein said fan speed is not reduced below certain vehicle speeds.

19. The method of claim 15 further including the step of monitoring a temperature signal.

20. The method of claim 19 further including the step of determining if said temperature signal is outside a desired range before adjusting the fan speed in response to changes in said vehicle speed signal.

21. The method of claim 20 further including the step of overriding said step of adjusting the fan speed in response to changes in said vehicle speed signal when said temperature signal is outside said desired range.

22. The method of claim 21 further including the step of ceasing said step of overriding when said temperature signal returns to within said desired range.
